(19) United States
(12) Patent Application Publication
(10) Pub. No.: US 2011/0116577 A1
(43) Pub. Date: May 19, 2011

(54) SEMICONDUCTOR DEVICE WIRELESS COMMUNICATION UNIT AND METHOD FOR RECEIVING A SIGNAL

(75) Inventor: Norman Beamish, Cork (IE)

(73) Assignee: Freescale Semiconductor, Inc., Austin, TX (US)

(21) Appl. No.: 13/055,480

(22) PCT Filed: Jul. 28, 2008
(86) PCT No.: PCT/IB2008/053025

§ 371 Date: Jan. 24, 2011

(51) Int. Cl. H04B 1/06

(52) U.S. Cl. 375/317

(57) ABSTRACT

A semiconductor device comprising receiver circuitry arranged to receive a dual carrier RF signal comprising a first wanted component and a second wanted component. The receiver circuitry is arranged to down convert the received dual carrier RF signal to create a Very Low Intermediate Frequency, VLIF signal whereby the first wanted component of the received dual carrier signal is subsequently located at a positive VLIF offset with respect to DC, zero hertz, and the second wanted component of the received dual carrier signal is subsequently located at a negative VLIF offset with respect to DC. The semiconductor device further comprises a signal processing logic module arranged to receive the VLIF signal and to separate the first and second wanted components of the received signal.

### FIELD OF THE INVENTION

The field of this invention relates to a semiconductor device, and more particularly to a semiconductor device comprising Radio Frequency (RF) receiver circuitry arranged to receive a dual carrier RF signal, a wireless communication unit comprising the semiconductor device and a method for receiving a dual carrier RF signal.

### BACKGROUND OF THE INVENTION

In the field of mobile communications, the ever increasing worldwide usage of radio frequency resources requires a continuous need to increase network capacities, coverage and data rates, whilst minimising impacts to network infrastructure.

The 3^{rd} Generation Partnership Project (3GPP) is responsible for many of the mobile communication standards in use today, such as the Global System for Mobile communications (GSM) and the Enhanced Data rates for GSM Evolution (EDGE). The 3GPP is currently considering evolving the GSM/EDGE Radio Access Network (GERAN), and have published proposals within 3GPP TR 45 912 ‘Feasibility study for evolved GSM/EDGE Radio Access Network (GERAN)’. A feature under consideration, discussed in 3GPP TR 45.912, is the use of multi-carrier downlink signals, whereby data to a single user can be transmitted on multiple carriers comprising independent carrier frequencies.

One option being considered for the implementation of such a multi-carrier downlink within a mobile station (MS) receiver by the 3GPP is to have separate receiver chains for each carrier. As a result, the multi-carrier terminals would comprise a plurality of receiver branches that can be tuned to different frequencies. FIG. 1 illustrates an example of such a proposed transceiver architecture 100 adapted to support a dual carrier downlink arrangement. As can be seen, the proposed implementation comprises two receiver chains 110, 120, one for each downlink carrier. Each receiver chain 110, 120 comprises down conversion circuitry 115, 125 operably coupled to a respective local oscillator (LO) signal LO1, LO2, and arranged to mix the dual carrier RF signal with the respective local oscillator signal LO1, LO2. Each local oscillator signal LO1, LO2 may be tuned such that, when mixed with the dual carrier RF signal, a wanted carrier component within the dual carrier RF signal is subsequently located at, for example, a Very Low Intermediate Frequency (VLIF), or in the case of a Direct Conversion Receiver (DCR), a Zero Intermediate Frequency (ZIF). In this manner, the conversion circuitry 115, 125 of each receiver chain 110, 120 down converts the dual carrier RF signal to locate one of the two wanted carrier components therein at the intermediate frequency.

Each of the receiver chains 110, 120 further comprises respective low pass filters 135, 145 (or band-pass filters) and respective Analogue to Digital Converter (ADC) circuitry 130, 140, which receive the respective down converted signal and filter and convert it into a corresponding digital signal, which can subsequently be processed within the digital domain, as is known in the art.

A problem with this proposed solution is that the use of multiple, substantially independent receiver chains, with each receiver chain arranged to process a respective downlink carrier signal, significantly increases the cost and area requirements for the MS receiver architecture, as well as the power consumption therefor. As will be appreciated, the cost, size and battery performance of mobile communication devices such as mobile telephone handsets, are key drivers in the design and development of such devices. As such, this proposed option for the implementation of a multi-carrier downlink within a wireless communications (e.g. a mobile station (MS)) receiver is undesirable.

An alternative option proposed by the 3GPP for the implementation of a multi-carrier downlink within a mobile station (MS) receiver comprises the use of a wideband receiver. The use of a wideband receiver would allow a single receiver chain architecture to be used for multiple-carrier downlink signals, whereby the wideband receiver is arranged to receive a suitably wide frequency band to encompass all carriers within the multi-carrier signal. The multiple carrier components may then be separated within the digital domain.

However, as will be appreciated, and as acknowledged in the 3GPP feasibility study for evolved GSM/EDGE Radio Access Network (GERAN) mentioned above, the increase in the passbands for the ADC circuitry and low pass filters significantly increases the complexity, and thereby development time and cost, for such receiver architecture. Accordingly, this alternative proposed option for the implementation of a multi-carrier downlink within an MS receiver is also undesirable.

### SUMMARY OF THE INVENTION

The present invention provides a semiconductor device, a method for receiving a dual carrier radio frequency signal, a wireless communication unit, a network element and a cellular communication system as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 illustrates an example of a known transceiver architecture.

FIG. 2 illustrates an example of a semiconductor device according to some embodiments of the invention.

FIG. 3 illustrates an example of a VLIF signal created by radio frequency circuitry of FIG. 2.

FIG. 4 illustrates an example of a simplified flowchart of a method for receiving a dual carrier radio frequency signal according to some embodiments of the invention.

FIG. 5 illustrates an example of a block diagram of part of a wireless communication unit adapted to support an embodiment of the invention.

FIG. 6 illustrates an example of a cellular communication system adapted according to some embodiments of the invention.

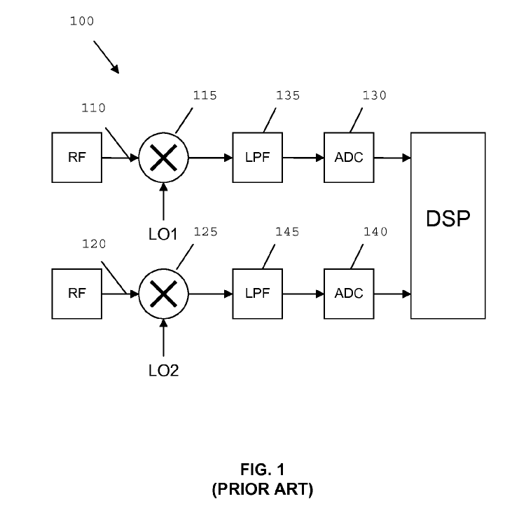

### DETAILED DESCRIPTION OF THE PREFERRED EMBODIMENTS

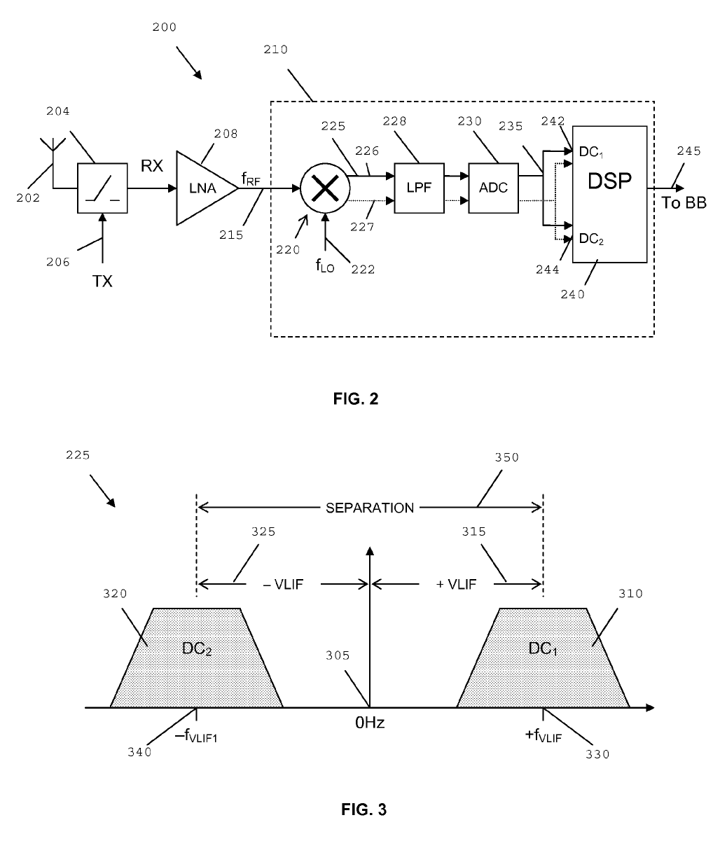

Referring now to FIG. 2, there is illustrated an example of a semiconductor device 210 according to some embodiments of the invention. For the illustrated embodiment, the semiconductor device 210 forms a part of a receiver chain 200 of, for example, a wireless communication device, such as a Mobile Station (MS) adapted in accordance with GSM (Global System for Mobile communication, EDGE (Enhanced Data rates for GSM Evolution) and/or UMTS (Universal Mobile Telecommunications System) technologies. For the illustrated embodiments, the receiver chain 200 further comprises a Low Noise Amplifier (LNA) 208 operably coupled to a front end switch 204, which in turn is operably coupled to an antenna 202. In this manner, RF signals received by the antenna 202 may be routed by the front end switch 204 to the LNA 208, which amplifies the received RF signals before providing them to the semiconductor device 210. As is known in the art, the front end switch 204 further acts to isolate the receiver chain 200 from a transmit chain 206.

The semiconductor device 210 comprises Radio Frequency (RF) receiver circuitry, which for the illustrated embodiment is in a form of mixer circuitry 220, arranged to receive a dual carrier RF signal 215 comprising a first wanted carrier component and a second wanted carrier component, the first and second wanted carrier components being located at different frequencies within the dual carrier RF signal. The mixer circuitry 220 is operably coupled to a local oscillator signal 222, and is arranged to mix the received dual carrier RF signal 215 with the local oscillator signal 222, and thereby down-convert the received dual carrier RF signal 215 to create a Very Low Intermediate Frequency (VLIF) signal 225, whereby the first wanted component of the received dual carrier signal is subsequently located at a positive VLIF offset with respect to DC (Direct Current), and the second wanted component of the received dual carrier signal is subsequently located at a negative VLIF offset with respect to DC. According to embodiments of the invention, the LO signal 222 is programmed to a mixing frequency that is substantially equidistant between the first and second wanted carrier components.

In accordance with some embodiments of the invention, the mixer circuitry 220 of FIG. 2 may comprise a complex down-mixing operation, in order to substantially avoid corruption of wanted components within the received dual carrier signal caused by alias signals creating images of the wanted components. For example, the mixer circuitry 220 may comprise two output signals in a form of a first in-phase (I) signal 226 and a second Quadrature (Q) signal 227.

Briefly turning to FIG. 3, FIG. 3 illustrates an example frequency domain representation of the VLIF signal 225 created by the RF receiver circuitry 220 of FIG. 2 following down-conversion of the received dual carrier RF signal 215. As previously mentioned, the received dual carrier RF signal 215 comprises a first wanted component 310 and a second wanted component 320. Following down-conversion of the received dual carrier RF signal 215 by the RF receiver circuitry 220, the first wanted component 310 is located generally at a positive VLIF offset 315 with respect to DC 305, and the second wanted component 320 is located generally at a negative VLIF offset 325 with respect to DC 305. In this manner, within the VLIF signal 225 created by the RF receiver circuitry 220, the first wanted component is located generally at a positive VLIF frequency 330, and the second wanted component is located generally at a negative VLIF frequency 340.

The semiconductor device 210 further comprises a signal processing logic module, which for the illustrated embodiment is in a form of a digital signal processing logic module 240, and which is arranged to receive the VLIF signal 225 and to separate the first and second wanted components 310, 320 of the received signal. Accordingly, for the illustrated embodiment in FIG. 2 the semiconductor device 210 further comprises Analogue to Digital Converter (ADC) circuitry 230, operably coupled to the RF receiver circuitry 220, and arranged to convert the VLIF signal 225 created by the RF receiver circuitry 220 into a substantially equivalent digital VLIF signal 235. The digital signal processing logic module 240 is operably coupled to an output of the ADC circuitry 230, and arranged to receive the substantially equivalent digital VLIF signal 235 such that the first and second wanted components 310, 320 may be separated and processed in a digital domain by the digital signal processing logic module 240. A low pass filter (LPF) 228 is provided between the RF receiver circuitry 220 and the ADC circuitry 230 in order to filter the analogue signal prior to it being converted into a substantially digital equivalent signal by the ADC circuitry 230, as is known in the art. In this manner, the ADC circuitry 230 is not required to support the conversion of frequencies filtered out by the narrow band filter 228.

As previously mentioned, and in accordance with some embodiments of the present invention, the mixer circuitry 220 of FIG. 2 may comprise a complex down-mixing operation, whereby the mixer circuitry 220 comprises ‘I’ and ‘Q’ output signals 226, 227. Accordingly, each of the ‘I’ and ‘Q’ outputs 226, 227 may be operably coupled to a separate LPF and ADC combination. In this manner, for the embodiment illustrated in FIG. 2, each connection illustrated to the right of the mixer circuitry 220 may be considered as comprising a complex connection, whereby each complex connection comprises an In-phase (I) connection and a Quadrature (Q) connection. Similarly, each of the LPF 228, ADC circuitry 230 and the digital signal processing logic 240 may be considered as comprising In-phase (I) and Quadrature (Q) functionality.

For the illustrated embodiments, the digital signal processing logic 240 comprises a single logic block arranged to receive the substantially equivalent VLIF signal 235 at two inputs 242, 244 thereof. In this manner, each input 242, 244 may be operably coupled to digital signal processing circuitry (not shown) within the digital signal processing logic 240 arranged to separate out one of the wanted carrier components from the received digital VLIF signal 235. For example, a first input 242 of the digital signal processing logic 240 may be operably coupled to digital signal processing circuitry comprising low pass digital filtering logic (not shown) arranged to filter out those parts of the received digital VLIF signal not located substantially about the positive VLIF frequency 330. Similarly, the second input 244 of the digital signal processing logic 240 may be operably coupled to digital signal processing circuitry comprising low pass digital filtering logic (not shown) arranged to filter out those parts of the received digital VLIF signal not located substantially about the negative VLIF frequency 340. The low pass filtered signals may then be conventionally processed as is known in the art to provide signals suitable for baseband processing comprising the wanted carrier components. Accordingly, for the illustrated embodiment, the digital signal processing logic 240 is arranged to output a baseband signal 245 comprising the wanted carrier components.

As previously mentioned, and in accordance with some embodiments of the invention, the mixer circuitry 220 of FIG. 2 may comprise a complex down-mixing operation, whereby the mixer circuitry 220 comprises I and Q output signals 226, 227. Accordingly, the digital signal processing logic 240 may comprise complex bandpass digital filters (not shown), as are known in the art.

As will be appreciated, by down-converting the received dual carrier RF signal 215, such that the first and second wanted components within the VLIF signal 225 are located generally at respective positive and negative VLIF frequencies 330, 340, a single receiver chain architecture, such as that illustrated in FIG. 2, is capable of receiving a dual carrier RF signal, and retrieving individual wanted carrier components therefrom. In this manner, the significant increase in cost and area requirements that arise due to the use of multiple, substantially independent receiver chains are substantially avoided.

Furthermore, it is anticipated that the VLIF signal 225, to which the received dual carrier RF signal 215 is down-converted, may typically comprise a frequency such that the first and second wanted components 310, 320 of the received dual carrier signal are located therein generally at positive and negative VLIF offsets 315, 325 comprising frequencies in the region of up to +/−250 kHz. Accordingly, the passbands for the ADC circuitry and low pass filters may be limited to a total span of approximately 500 kHz. This is in contrast to a wideband receiver that is arranged to receive a suitably wide frequency band to encompass all carriers within a multi-carrier signal, which could require the passbands for the ADC circuitry and low pass filters to be as high as 75 MHz.

Thus, by down-converting the received dual carrier RF signal 215, such that the first and second wanted components within the VLIF signal 225 are located generally at respective positive and negative VLIF frequencies 330, 340, the passband for the ADC circuitry 230, and/or low pass filter 228 is not required to be significantly increased relative to that of a more traditional, single carrier downlink receiver architecture. Accordingly, the complexity of the ADC circuitry 230 and/or low pass filter 228, and thereby the development time and cost, is also not increased. Indeed, existing ADC and low pass filter circuitry currently used within, for example, single carrier downlink receiver architectures may be used within the dual carrier architecture of FIG. 2, thereby significantly improving development time and cost for such a dual carrier downlink architecture.

In accordance with some embodiments of the invention, the RF receiver circuitry 220 is arranged to receive a constrained dual carrier RF signal 215, whereby the first and second wanted components 310, 320 comprise a substantially fixed separation 350 there between. In this manner, the first and second wanted components 310, 320 within the VLIF signal 225 may be located at substantially fixed VLIF frequencies 330, 340. For example, the separation 350 between the wanted components within the received dual carrier RF signal may be fixed at approximately 200 kHz. Accordingly, the RF receiver circuitry 220 may be arranged to down-convert the received dual carrier RF signal 215 to create a VLIF signal 225 whereby the first wanted component 310 is subsequently located at a positive VLIF offset of approximately 100 kHz with respect to DC 305, and the second wanted component 320 is subsequently located at a negative VLIF offset of approximately −100 kHz with respect to DC 305. In this manner, the separation between the wanted components is sufficiently small that existing ADC and low pass filter circuitry currently used within, for example, some single carrier downlink receiver architectures may be suitable for use within such a dual carrier architecture.

Alternatively, the separation 350 between the wanted components within the received dual carrier RF signal 215 may be fixed at approximately 400 kHz. In this manner, the RF receiver circuitry 220 is arranged to down convert the received dual carrier RF signal 215 to create a VLIF signal 225 whereby the first wanted component 310 is subsequently located at a positive VLIF offset of approximately 200 kHz with respect to DC 305, and the second wanted component 320 is subsequently located at a negative VLIF offset of approximately −200 kHz with respect to DC 305.

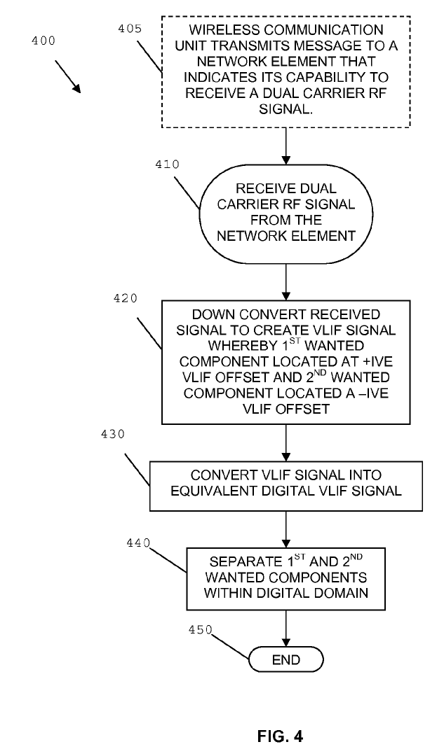

Referring now to FIG. 4, there is illustrated an example of a simplified flowchart 400 of a method for receiving a dual carrier RF signal adapted according to some embodiments of the invention, for example as may be implemented within a receive chain of an MS RF transceiver.

The method starts at step 405, where a wireless communication unit, such as a mobile station, optionally transmits a message to a network element that indicates the MS's capability to receive a dual carrier RF signal. The method moves to step 410 with the receipt of a dual carrier RF signal comprising a first wanted component and a second wanted component, for example a dual carrier RF signal within a cellular communication system such as a GERAN (GSM/EDGE Radio Access Network) cellular communication system, or other 3GPP cellular communication system. In accordance with some embodiments of the invention, the received dual carrier RF signal may comprise a constrained dual carrier RF signal, whereby the first and second wanted components comprise a substantially fixed frequency separation.

Next, in step 420, the received dual carrier signal is down-converted to create a VLIF signal, whereby the first wanted component of the received dual carrier signal is subsequently located generally at a positive VLIF offset with respect to DC, and the second wanted component of the received dual carrier signal is subsequently located generally at a negative VLIF offset with respect to DC. In this manner, the frequency separation between the wanted components is sufficiently small that existing ADC and low pass filter circuitry currently used within, for example, some single carrier downlink receiver architectures may be suitable for use for performing the method of receiving a dual carrier signal.

Next, in step 430, the method comprises converting the VLIF signal into a substantially equivalent digital VLIF signal. As will be appreciated, the analogue VLIF signal may be filtered by way of a low pass filter to remove unwanted, higher frequency components, thereby simplifying the conversion of the analogue VLIF signal to a substantially equivalent digital VLIF signal.

The first and second wanted components are then separated within the digital domain, in step 440 and subsequently further processed independently. The method then ends at step 450.

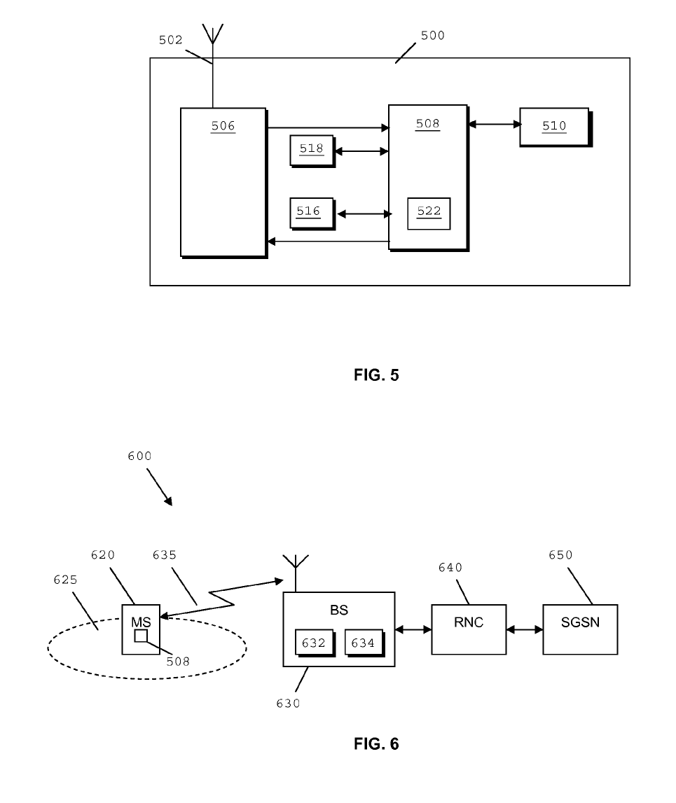

Referring now to FIG. 5, there is illustrated an example of a block diagram of part of a wireless communication unit 500, adapted to support an embodiment of the invention. The communication unit 500, in the context of the illustrated embodiment of the invention, is a mobile station (MS) comprising an antenna 502. As such, the communication unit 500 contains a variety of well known radio frequency components or circuits 506, operably coupled to the antenna 502. In accordance with embodiments of the invention, the receiver circuitry 506 is arranged to receive a dual carrier RF signal comprising a first wanted component and a second wanted component, and to down-convert the received dual carrier RF signal to create VLIF signal whereby the first wanted component of the received dual carrier signal is subsequently located at a positive VLIF offset with respect to DC, and the second wanted component of the received dual carrier signal is subsequently located at a negative VLIF offset with respect to DC.

For completeness, the communication unit 500 further comprises signal processing logic 508. An output from the signal processing logic 508 is provided to a suitable user interface (UI) 510 comprising, for example, a display, keypad, loudspeaker and/or microphone. The signal processing logic 508 may be operably coupled to a memory element 516 that stores operating regimes, such as decoding/encoding functions and the like and may be realised in a variety of technologies such as random access memory (RAM) (volatile), (non-volatile) read only memory (ROM), Flash memory or any combination of these or other memory technologies. A timer 518 is typically coupled to the signal processing logic 508 to control the timing of operations within the communication unit 500.

As previously mentioned, by down-converting the received dual carrier RF signal 215, such that the first and second wanted component within the VLIF signal 225 are located generally at respective positive and negative VLIF frequencies, a single receive chain architecture, such as that illustrated in FIG. 2, is capable of receiving a dual carrier RF signal, and retrieving the wanted carrier components therefrom. In this manner, the significant increase in cost and area requirements that arise due to the use of multiple, substantially independent receiver chains are substantially avoided, thus facilitating keeping the cost and size of the MS 500 low. Furthermore, since only a single receiver chain is required, the power consumption of the transceiver circuitry of the MS 500 may be reduced, thereby reducing the impact on the battery life of the MS 500. Furthermore, the passbands for ADC and low pass filter circuitry are not required to be significantly increased relative to that of more traditional, single carrier downlink receiver architecture. Accordingly, the complexity of the ADC and low pass filter circuitry, and thereby the development time and cost, is also not increased, further facilitating keeping the cost of the MS 500 low.

Referring now to FIG. 6, there is illustrated an example of a cellular communication system 600 adapted according to some embodiments of the invention. For example, the cellular communication system may comprise a cellular communication system according to a 3GPP standard, such as a GERAN (GSM/EDGE Radio Access Network) cellular communication system. Accordingly, for the illustrated embodiment, the cellular communication system 600 comprises a network element 630, for example in the form of a base station, arranged to support communication within a communication cell 625 of the cellular communication system 600 over an air interface 635. The network element 630 comprises transceiver circuitry 632 arranged to enable communication with at least one wireless communication unit 620 located within the communication cell 625. The transceiver circuitry 632 is further arranged to transmit a constrained dual carrier Radio Frequency (RF) signal comprising a first wanted component and a second wanted component, the first and second wanted components comprising a substantially fixed frequency separation there between. Furthermore, the separation between the first and second wanted components is such that, upon down-conversion of the dual carrier RF signal to a Very Low Intermediate Frequency (VLIF) signal, the first wanted component is substantially located at a positive VLIF offset with respect to DC and the second wanted component is substantially located at a negative VLIF offset with respect to DC.

In this manner, the cellular communication system 600, and in particular the network element 630, are able to transmit data across a downlink to a wireless communication unit 620 using two carriers, allowing up to almost double the downlink data rate of a single carrier downlink, whilst minimising the impact on the required enhancements for the receiver of the receiving wireless communication unit 620, and also minimising the hardware requirements for the network to be able to offer substantially double transfer rates to a select group of users.

In accordance with some embodiments of the invention, the wireless communication unit 620 may comprise signal processing logic, for example such as signal processing logic 508 of the wireless communication unit 500 of FIG. 5, the signal processing logic 508 being arranged to provide an indication to the network element 630 with which the wireless communication unit 620 is connected that the wireless communication unit 620 is capable of supporting a constrained dual carrier RF signal. Correspondingly, the network element 630 may comprise signal processing logic 634 arranged to receive an indication from the wireless communication unit 620 connected thereto that the wireless communication unit 620 is capable of supporting a constrained dual carrier RF signal, and upon receipt of such an indication, to communicate with the wireless communication unit 620 using a constrained dual carrier RF downlink. In an alternative embodiment of the invention it is envisaged that the MS may receive two separate and district signals concurrently from two independent base stations, for example one broadcast transmission and one point-to-point transmission. In this manner, the MS may be able to concurrently receive two different signals from two different sources and differentiate between the received transmissions in the digital domain.

In accordance with some further embodiments of the invention, the signal processing logic module 634 of the network element 630 may be arranged determine whether to enable a constrained dual carrier RF downlink signal between itself and a wireless communication unit. For example, upon receipt of an indication from a wireless communication unit indicating that the wireless communication unit is capable of supporting a constrained dual carrier RF downlink signal, the signal processing logic module 634 may determine whether to enable a dual carrier RF downlink signal based on, for example, RF channel conditions, network traffic levels, and/or on a level of service purchased by a user of the wireless communication unit.

For completeness, the cellular communication system 600 may further comprise a Radio Network Controller (RNC) 640 operably coupled to the network element 630, and, say, a Serving GPRS (General Packet Radio Service) Support Node (SGSN) 650 operably coupled to the RNC 640.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

The semiconductor device described herein may comprise any suitable semiconductor material or combinations of materials, such as gallium arsenide, silicon germanium, silicon-on-insulator (SOI), silicon, monocrystalline silicon, the like, and combinations of the above.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The description of the architecture has been simplified for purposes of discussion, and is envisaged at just being one of many different types of appropriate architecture that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A semiconductor device for use in a wireless communication unit comprising:
a signal processing logic module arranged to provide, to a network element with which the wireless communication unit is connected, an indication that the wireless communication unit is capable of supporting a dual carrier radio frequency (RF) signal;
receiver circuitry arranged to receive, in response to the indication, the dual carrier RF signal comprising a first wanted component and a second wanted component;
the receiver circuitry is further arranged to down convert the received dual carrier RF signal to create a Very Low Intermediate Frequency (VLIF) signal, wherein
the first wanted component of the received dual carrier signal is subsequently located generally at a positive VLIF offset with respect to zero DC, hertz, and
the second wanted component of the received dual carrier signal is subsequently located generally at a negative VLIF offset with respect to DC;
the signal processing logic module is further arranged to receive the VLIF signal and to separate the first and second wanted components of the received signal.

2. The semiconductor device of claim 1 further comprising:
the receiver circuitry further arranged to receive a constrained dual carrier RF signal, wherein the first and second wanted components comprise a fixed frequency separation there between.

3. The semiconductor device of claim 1 wherein the semiconductor device further comprises:
Analogue to Digital Converter (ADC) circuitry, operably coupled to the receiver circuitry, and arranged to convert an analogue VLIF signal created by the receiver circuitry into an equivalent digital VLIF signal, such that the first and second wanted components of the received signal are separated within a digital domain.

4. The semiconductor device of claim 3 wherein the signal processing logic module is operably coupled to an output of the ADC circuitry, and arranged to receive the equivalent digital VLIF signal, and to separate the first and second wanted components contained therein.

5. The semiconductor device of claim 1 further comprising:
the receiver circuitry further arranged to down-convert the received dual carrier RF signal to create a VLIF signal, wherein
the first wanted component is subsequently located at a positive VLIF offset of approximately 100 kHz with respect to DC, and
the second wanted component is subsequently located at a negative VLIF offset of approximately −100 kHz with respect to DC.

6. The semiconductor device of claim 1 further comprising:
mixer circuitry arranged to down-convert the second wanted component of the received dual carrier RF signal using a local oscillator signal that is equidistant in frequency from the first wanted component and the second wanted component.

7. The semiconductor device of claim 1 wherein the receiver circuitry comprises:
two outputs configured to provide a first in-phase (I) signal and a second Quadrature (Q) signal, and each of the I and Q outputs is operably coupled to a separate low pass filter (LPF) and analogue to digital converter (ADC) combination.

8. The semiconductor device of claim 1 wherein the received dual carrier RF signal comprises a downlink dual carrier RF signal within a cellular communication system according to a 3rd Generation Partnership Project (3GPP) standard.

9. The semiconductor device claim 1 wherein the received dual carrier RF signal comprises a downlink dual carrier RF signal within a GSM/EDGE Radio Access Network (GERAN) cellular communication system.

10. A method comprising:
providing an indication to a network element of a capability to receive a dual carrier radio frequency (RF) signal;
receiving the dual carrier RF signal comprising a first wanted component and a second wanted component;
down-converting the received dual carrier signal to create a Very Low Intermediate Frequency (VLIF) signal, wherein
the first wanted component of the received dual carrier signal is subsequently located at a positive VLIF offset with respect to DC, zero hertz, and
the second wanted component of the received dual carrier signal is subsequently located at a negative VLIF offset with respect to DC; and
separating the first and second wanted components of the received signal within a digital domain.

11. A wireless communication unit comprising:
receiver circuitry arranged to receive a dual carrier radio frequency (RF) signal comprising a first wanted component and a second wanted component;
the receiver circuitry further arranged to down-convert the received dual carrier RF signal to create a Very Low Intermediate Frequency (VLIF) signal, wherein
the first wanted component of the received dual carrier signal is subsequently located at a positive VLIF offset with respect to zero hertz DC, and
the second wanted component of the received dual carrier signal is subsequently located at a negative VLIF offset with respect to DC;
a signal processing logic module arranged to receive the VLIF signal and to separate the first and second wanted components of the received signal, wherein
the signal processing logic module is also arranged to provide an indication to a network element, with which the wireless communication unit is connected, that the wireless communication unit is capable of supporting a dual carrier RF signal.

12. The wireless communication unit of claim 11 further comprising:
the receiver circuitry further arranged to receive a constrained dual carrier RF signal, wherein the first and second wanted components comprise a fixed separation there between.

13. (canceled)

14. (canceled)

15. The wireless communication unit of claim 11 further comprising:
Analogue to Digital Converter (ADC) circuitry, operably coupled to the receiver circuitry, and arranged to convert an analogue VLIF signal created by the receiver circuitry into an equivalent digital VLIF signal, such that the first and second wanted components of the received signal are separated within a digital domain.

16. The wireless communication unit of claim 15 wherein the signal processing logic module is operably coupled to an output of the ADC circuitry, and arranged to receive the equivalent digital VLIF signal, and to separate the first and second wanted components contained therein.

17. The wireless communication unit of claim 11 further comprising:
the receiver circuitry further arranged to down-convert the received dual carrier RF signal to create a VLIF signal, wherein
the first wanted component is subsequently located at a positive VLIF offset of approximately 100 kHz with respect to DC, and
the second wanted component is subsequently located at a negative VLIF offset of approximately −100 kHz with respect to DC.

18. The wireless communication unit of claim 11 further comprising:
mixer circuitry arranged to down-convert the second wanted component of the received dual carrier RF signal using a local oscillator signal that is equidistant in frequency from the first wanted component and the second wanted component.

19. The wireless communication unit of claim 11 wherein the receiver circuitry further comprises:
two outputs configured to provide a first in-phase (I) signal and a second Quadrature (Q) signal, and each of the I and Q outputs is operably coupled to a separate low pass filter (LPF) and analogue to digital converter (ADC) combination.

20. The method of claim 10 further comprising:
receiving a constrained dual carrier RF signal, wherein the first and second wanted components comprise a fixed frequency separation there between.

21. The method of claim 10 further comprising:
down-converting the received dual carrier RF signal to create a VLIF signal, wherein
the first wanted component is subsequently located at a positive VLIF offset of approximately 100 kHz with respect to DC, and
the second wanted component is subsequently located at a negative VLIF offset of approximately −100 kHz with respect to DC.

22. The method of claim 10 further comprising:
down-converting the second wanted component of the received dual carrier RF signal using a local oscillator signal that is equidistant in frequency from the first wanted component and the second wanted component.
